(19) United States
(12) Patent Application Publication
(10) Pub. No.: US 2014/0356819 A1
(43) Pub. Date: Dec. 4, 2014

(54) PORTABLE ELECTRONIC BRAILLE READER

(71) Applicant: Mauricio Rodriguez Regalado, Guadalajara (MX)

(72) Inventor: Mauricio Rodriguez Regalado, Guadalajara (MX)

(21) Appl. No.: 14/344,692

(22) PCT Filed: Sep. 13, 2011
(86) PCT No.: PCT/MX2011/000106

§ 371 Date: Mar. 13, 2014

(51) Int. Cl. G09B 21/00

(52) U.S. Cl. CPC G09B 21/004
USPC 434/114

(57) ABSTRACT

A portable electronic Braille reader which includes a capacitive screen to which information is input via an input port or any other suitable means, which information is decoded and coded by a microprocessor in order to convert the information into Braille characters; a thimble which includes elements capable of generating a stimulus in the reader's finger so that the reader recognizes the characters represented on the screen, and guide lines for ensuring that the thimble slides in the correct direction and on the correct trajectories during reading.

### FIELD OF THE INVENTION

The invention relates to electronic readers, and more particularly to a portable electronic Braille reader that allows visually impaired or blind people to “read” any printed material that is incorporated to such reader by any suitable means known or unknown.

### BACKGROUND OF THE INVENTION

The Spanish patent ES 2202570 describes a portable reading device for the blind that integrates optical sensors capable of processing printed text, an electronic system that stores software adapted to recognize printed characters as well as a conversion software of such characters into Braille characters, touch recognition area and a microcapsule attached to a sheath at the tip of the blind person's index finger much like a thimble is introduced. The microcapsule contains an optical sensor array provided with a lens and an electromagnetic unit designed to display Braille character by character on a touch surface, as soon as the blind person's index finger is moved over a printed character and when the finger is exactly on that character. Such electromagnetic unit integrates six magnets intended to reproduce Braille characters and two intended to tell the reader a mistake in direction; the latter are activated if the blind person deviates his/her index finger up or down from the line of text.

One difference between the reading device of the aforementioned Spanish patent and the new reader, is that the latter does not use an optical character recognition procedure (OCR) to enter the device the reading the text you want to make available to the blind. In the new reader, the information to be loaded is electronic files that are converted to Braille text. Therefore, the reader of the present invention does not require optical sensors, nor the software associated to that procedure of recognition, but as the entry of data to the new reader will be described later, can be done through storage media information (USB stick, CD, DVD) or via internet. Logically, the latter procedure is much more versatile, reliable and prompt than the use of optical sensors.
Another important difference between the Spanish Patent and the reader is that the new reading device that does not have a receptive screen, while the new reader itself does. Another substantial difference is that the new reader has the ability to receive information, in the future, via WiFi, while the device of the Spanish patent does not. Another noticeable difference is that the Braille cell in the reader's thimble be actuated by electromagnets or by so called “muscle wire”. Because the source text is electronic files, with the new reader the problem that the Spanish patent has regarding reading different size text or what is the distance between the text and the thimble is not present.

### OBJECTS OF THE INVENTION

The main object of the invention is to propose a new portable electronic Braille reader characterized in that it comprises a capacitive screen, which consists of a display that by means of direct touch on the surface allows entry of data and commands to the portable electronic reader; the information to be read in the screen is entered through a port of entry or any other suitable means. Such information is encoded and decoded by a microprocessor to convert it into Braille characters that can be recognized by a thimble that is placed on the index finger of a blind person, which for this purpose includes a braille cell with elements capable of generating stimulus on the finger of the reader so the person can recognize the Braille characters that correspond to specific positions on the screen, and a guide line to ensure that the thimble slides into the correct direction and paths while reading.

The capacitive screen makes that when the reader when presses in an X, Y coordinate this sends a signal to the thimble and indicates that the Braille cell must raise and lower points of the cell to form a letter. When you move to the right one position, that is the X +1, Y coordinate, the display sends electronic impulses to report that in that position corresponds to another letter in Braille, which makes the thimble up or down points braille cell to form the new letter from that position.

### BRIEF DESCRIPTION OF THE FIGURES OF THE INVENTION

FIG. 1 is a schematic view showing the main components of the portable electronic braille reader of the present invention.

FIG. 2 is the reader's capacitive screen which contains the information that was previously stored therein for reading.

FIG. 3 is a perspective view of an exemplary embodiment of the thimble which is an essential element of the reader of the present invention.

FIG. 4 is a view showing the components of the braille cell that is housed in the thimble of the electronic reader.

FIG. 5 shows the relationship between the capacitive screen and the thimble of the electronic braille reader.

FIG. 6 shows how the thimble has a notch that prevents it from being positioned over the receptive screen if it is not aligned with the lower guide. This ensures that when you start reading, the person always has the portable electronic Braille reader in the right direction.

FIG. 7 is illustrative of the guide system used to keep e-reader from leaving the line being read.

FIG. 8 is an exemplary model of an embodiment of the portable electronic braille reader assembled of the present invention.

### DETAILED DESCRIPTION OF THE PREFERRED EMBODIMENT OF THE INVENTION

An electronic Braille reader so blind people can access printed material such as books, magazines and newspapers, which allows the blind to read a whole page in Braille. The reading device of the present invention is portable and by accessing the internet or inserting a USB, CD or DVD, or any other known or to be known format, is loaded with files that are decoded for reading.

The main parts that make up the e-reader (100) are:

Upper Housing (10)

Lower Housing (20)

Battery (30)

USB Connector (40)

Microprocessor (PCBA) (50)

Action Buttons (60, 62, 64)

Capacitive Screen (70)

Thimble (80)

Guide Lines (90)

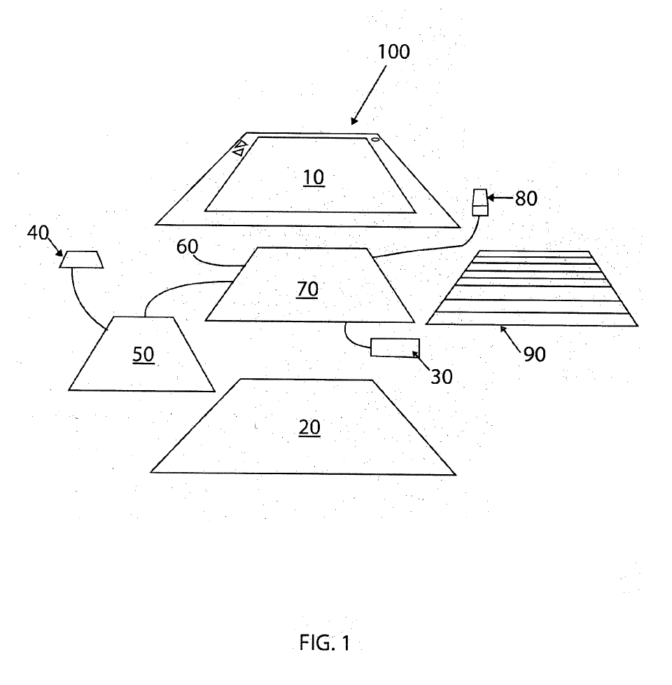

FIG. 1 shows the electronic reading device (100) in disassembled conditions to clearly reveal the main elements in it, wherein the lower housing (20) and the upper housing (10) aim to provide protection and union to the USB (40) connector, the action buttons (60), the microprocessor (50), which may be a printed circuit board PCBA, the capacitive screen (70), the battery (30) and the guide lines (90). The capacitive screen can be like the ones used by other devices commonly known as “touch screen”, i.e. iPad or iPhones, where certain commands are executed by direct touch on the screen surface.

The source of power of the electronic reader (100) may be a rechargeable lithium-iron-phosphate battery (30) whose advantage over lithium-phosphate (commonly used in cell phones and laptops) is that they are non-toxic to the environment, do not explode, do not corrode or suffer damages due to high fluctuations in ambient temperature and has a shelf life of 5-6 years.

The USB connector (40) is the input port of the information that will be accessible to the blind person. Such information is received by the USB connector (40) and taken to the printed circuit board (PCBA) (50) to be decoded. The PCBA will be adapted to control the functions of the reader. Powered by battery (30), the PCBA receives the files from the USB connector (40), and decodes and encodes them so they can be read by the capacitive screen (70). The PCBA (50) also receives signals from the action buttons (60, 62, 64), which allows to turn on/off the electronic reader (100) and go page forward/back. The source file you enter the reading device can be in a txt, doc, pdf format or any other format. That file source enters through the USB port, and an specially developed software that is built into the processor translates each letter of the text to correspond to an specific coordinate on the screen (70).

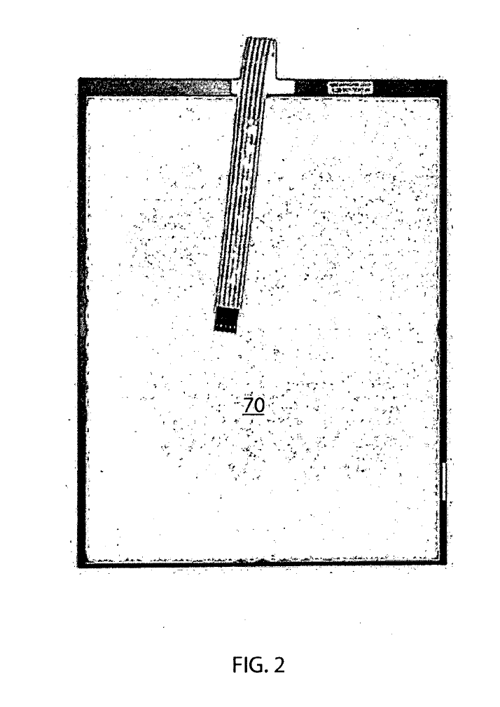

The capacitive screen (70) is a touch screen (FIG. 2) which by direct touch on its surface allows the entry of data and commands to the portable electronic reader. After receiving the information from the PCBA, the capacitive screen (70) contain information equivalent to a written page. The thimble (80) is connected to the circuit board (PCBA), and by placing the thimble on a particular point of the capacitive screen, the latter recognizes the coordinate at which the thimble (80) is positioned and determines that which Braille character corresponds to that particular coordinate and sends a signal to the thimble to raise and lower the relevant points of the Braille cell. Each character that make up the words is associated with an X,Y coordinate on the screen. The screen shows nothing, it is blank. What the screen does is that when readers presses on the X,Y coordinate, it will send a signal to the thimble and dictate the Braille cell which points must be raised and lowered to form a letter. When you go to the next position on the right, the X +1,Y coordinate, the display sends electronic impulses to report that that location corresponds to another letter in Braille, which makes the thimble to lower and raise the points of the Braille cell to form the new letter corresponding to that new position on the screen.

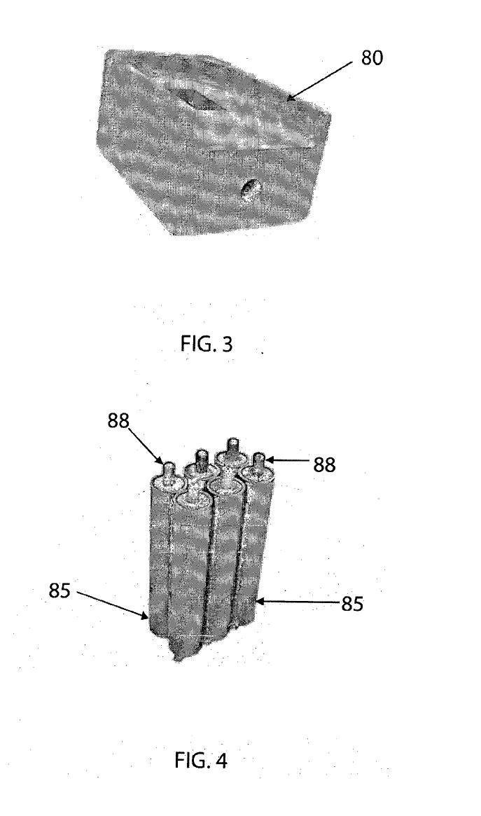

Another component of the portable electronic Braille reader is the thimble (80), shown as an example in FIG. 3, which is a piece that is placed in the tip of the index finger of the blind person and is adapted to be secured to the finger by any appropriate means. The thimble (80) is operatively connected to the PCBA (50) via a cable that allows you to receive signals from it. It is understood that it may also be implemented whatever is necessary for the connection between the thimble (80) and the PCBA (50) to be wireless.

In FIG. 4, represents a braille cell that is housed in the thimble, which consists of a set of electromagnets (85) that are arranged in an array of two columns of three electromagnets each. Each electromagnet (85) has housed in its center, an iron cylinder (88) of approximately 1.5 mm in diameter, which when subjected to electromagnetic force of the electromagnets can be lifted from its initial position of rest, to a height of approximately 0.5 mm.

The electromagnets (85) operate independently of one another, so that the combination of lift and hold down of the cylinders (88) allows for Braille characters to be formed, based on the information entered into the reader for reading.

By placing the thimble (80) on a particular point of the capacitive screen, it detects its position relative to an X,Y coordinate and sends the signal to the thimble, which inside contains a Braille cell, to lift the equivalent points of the letter for that position on the screen. A Braille cell consists of six or eight points for displaying Braille characters. These points, unlike the ones in a printed braille, can alternate between raised and lowered positions, so they can vary dynamically.

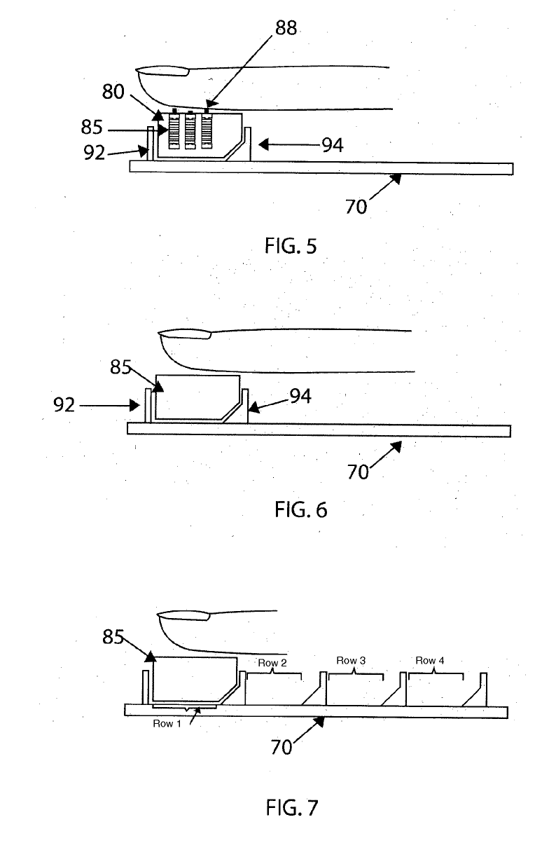

FIG. 5 is a representation that shows the use of the electronic reader (100), which shows how the thimble (80) is placed on the receptive screen and slides laterally so it reads the data that has been previously admitted to the reader. To maintain a linear trajectory while sliding the thimble through the lines of the display, there is a guide line (90) provided, which consists of a grid is placed over the capacitive screen (70). Through the guide lines (90) the blind reader is indicated the correct direction of the page and makes sure that the blind reader stays on the line to be read.

The guide lines (90) comprises of an upper guide (92) and a lower guide (94) which together define a path or passage through which the thimble (80) is to slide as it reads the information on the capacitive screen. The thimble (80) has a notch (88) which prevents the thimble from being positioned over the receptive screen if it is not aligned with the complementary recessed surface (95) provided on the lower guide (94). This ensures that to start reading, you always have the e-reader in the correct position and therefore in the direction of correct reading.

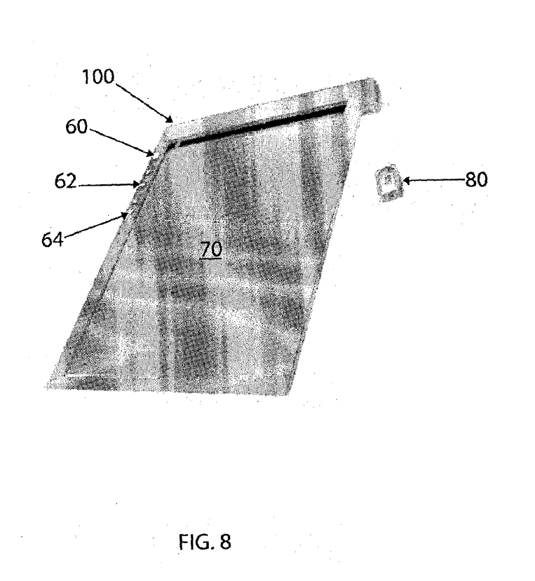

Another function of the guide (90) is to keep the reader from departing from the line they are reading. The upper guide (92) and the lower guide (94) define the path from one end to the other end of the screen, that the reader must follow while reading. Once the reader has finished reading a line, it must place the thimble (80) on the left edge of the next lower line, and so on up through all the rows of the page (FIG. 7).

As shown in FIG. 5, the cylinders (86) inserted in the electromagnets (85) adapted to move up and down, have, concerning elevation, an independent relationship to each other as a result of the electromagnetic force exerted on them because of the Braille character corresponding to a particular position on the screen (70), which depends on the information entered into the electronic reader. Thus, the reader will perceive in his index finger the character or letter of that particular position on the screen.

Once all lines on the receptive screen (70) have been read, the blind reader press the action button (64) provided in the electronic reading device (100) to advance to the next page. The PCBA (50) receives the respective command and provides new information to the screen to be read by the reader. At the same time, the reader places the thimble on the left edge of the first row and repeats the reading process that took place on the previous page. In the event that the user has a doubt about the previously read content, the user can press the action button (62) to return the page and PCBA (50) provides the capacitive screen with the previously accessed information.

FIG. 8 shows an exemplary assembled model of the portable electronic Braille reader (100) previously described. It is to be understood that the embodiment of the reader can be similar or different from the one illustrated in this figure and that this does not imply that it differs or diverts from the structural and functional concept as described hereinabove.

Although the invention has been described in the context of preferred embodiments, it will be apparent to those skilled in the art that the scope of the concept extends beyond the specifically disclosed model to other possible embodiments of the invention that are obvious and deducible from the contents of the foregoing description. Moreover, while the invention has been described in detail, one skilled in the art to which the invention pertains may deduce that some identified components can be replaced by others different or similar.

Given the above, it is understood that one or more of the primary or secondary elements of e-reader can be combined with others, or replaced by others giving shape to a reader with the previously described features. Accordingly, it is intended that the scope of the present invention is not interpreted in terms of the particular embodiments disclosed, but it is determined by reasonable interpretation of the content of the following claims.

It is established that the best way to implement the present invention is that which follows the actual content of the foregoing description.

1. Portable electronic Braille reader, comprising of:
A protective housing which contains inside:
a) A capacitive screen capable of receiving and storing information via any suitable means and makes it available so a blind person can read in Braille, also such display is adapted to input data or commands by tapping;
b) Means for inputting information to the e-reader;
c) A microprocessor for decoding the information entered to the reader and encode it so it can be read by capacitive screen;
d) Some action buttons through which certain signals are sent to the microprocessor to turn on/off the electronic reader and go forward/back on the pages;
e) A power supply as to provide the reader with power;
f) A guide line to ensure that the thimble slides over the lines in the right direction and follow a linear path from one end to the other end of the screen;
A thimble connected to the microprocessor and adapted to be slid over the capacitive screen as to allow a user to perceive the corresponding characters of the decoded and coded information that was previously entered into the reader, such thimble includes a braille cell comprising of magnetic elements that generate an electromagnetic force, and that each has a cylinder inserted therein, which can be raised independently from each other, to enable blind people to perceive, in a specific position of the thimble over the capacitive screen, a certain braille character.

2. The electronic reader of claim 1, in which the guide lines extend from one end to other end of the screen along the trajectory of a reading row.

3. The electronic reader of claim 1, wherein the guide lines and the thimble are configured to engage in a complementary way whereby the correct positioning of such said thimble over the receptive screen is ensured.

4. The electronic reader of claim 1, wherein the guide lines consist of a grid which is placed on top of the capacitive screen to define the paths to be followed by the thimble during the reading process.

5. The electronic reader of claim 1, wherein the means for entering information to the reader is an input port.

6. The electronic reader of claim 1, wherein the information is entered through a USB reader, a CD, DVD or any other storage medium of the readable information for the computer.

7. The electronic reader of claim 1, wherein reading information is downloaded from the internet and entered into the reader.

8. The electronic reader of claim 1, wherein the guide lines and the thimble together define a mean for ensuring that such said thimble is correctly positioned over the receptive screen.

9. The electronic reader of claim 1, wherein communication between the microprocessor and the thimble can be wired or wireless.

10. The electronic reader of claim 1, in which each character forming the words is associated with an X,Y coordinate on the screen.
